(19) United States
(12) Patent Application Publication
(10) Pub. No.: US 2026/0160618 A1
(43) Pub. Date: Jun. 11, 2026

(54) Azimuthally Differentiable Fiber Sensing

(71) Applicant: Regents of the Univ of Colorado, a body corporate, Denver, CO (US)

(72) Inventors: Juliet Gopinath, Boulder, CO (US); Katelynn Wootten, Lakewood, CO (US); Mo Zohrabi, Longmont, CO (US); Mark Siemens, Denver, CO (US)

(73) Assignee: Regents of the Univ of Colorado, a body corporate, Denver, CO (US)

(21) Appl. No.: 19/283,102

(22) Filed: Jul. 28, 2025

Related U.S. Application Data
(60) Provisional application No. 63/675,914, filed on Jul. 26, 2024.

(51) Int. Cl. G01L 1/24; G01K 11/32

(52) U.S. Cl. CPC G01L 1/242; G01K 11/32

(57) ABSTRACT

An azimuthally differentiable fiber sensor has two parallel optical fibers having spatially dependent indices of refraction in parallel with their direction of asymmetry rotated with respect to each other. The pair of optical fiber is placed in an environment to be monitored. A coherent light beam is provided to an orbital angular momentum (OAM) fiber generation assembly, which provides two diffracted mode beams which are provided to the pair of optical fibers. An optical twist measurement assembly measures the OAM of the environmentally affected beams from the pair of fibers, and processes it to determine the intensity and the direction of force applied to the pair of fibers.

This invention was made with government support under grant number 1826542 awarded by the National Science Foundation. The government has certain rights in the invention.

### BACKGROUND OF THE INVENTION

### Field of the Invention

The present invention relates to detecting changes in properties such as temperature and strain with fiber sensing. In particular, the present invention relates to detecting changes in properties such as temperature and directional force with fiber sensing based on orbital angular momentum (OAM).

### Discussion of Related Art

Optical fiber sensors are useful for measuring temperature, strain, pressure, vibrations, and refractive index. In particular, fiber sensors are attractive for remote sensing over long distances and in places where immunity to electromagnetic interference is important. These devices are also lightweight, compact, sensitive, and suitable for harsh environments. Fiber sensors can be implemented to monitor structures, pipelines, oil and gas reservoirs, wellbores, as well as temperature changes in dams and permafrost. They can also be applied to rail-track monitoring, detection of earthquakes and water swells, and load displacement monitoring in mines. Thus, fiber sensors can play a role in preventing and mitigating the social, economic, and environmental costs of accidents and natural disasters.

### SUMMARY OF THE INVENTION

An optical fiber sensor uses the orbital angular momentum of light in a polarization maintaining fiber to act as a temperature and/or force sensor. The polarizations of the input light are chosen to determine the sensitivity of the sensor. In addition, the direction of a force exerted upon the fiber is determined and resolved. With the ability to resolve the direction of a force, the fiber can be used for shape sensing.

Azimuthally resolved sensing is enabled by the asymmetric nature of the polarization maintaining fiber that affects the spatially patterned light. An OAM generation assembly generates spatially patterned light having OAM. An optical fiber assembly includes at least two asymmetric index of refraction optical fibers in parallel with an axis of asymmetry of one of the fibers rotated with respect to an axis of asymmetry of the other fiber. An optical twist assembly measures changes in average OAM over time.

The OAM generation assembly introduces the spatially patterned light to the two fibers, the environment acts on the fibers, and the optical twist measurement assembly receive lights exiting from the two fibers and measures the change in average OAM of each exiting beam.

An azimuthally differentiable fiber sensor embodiment includes two optical fibers having asymmetric spatially dependent indices of refraction and disposed in parallel in an environment, wherein an axis of asymmetry of one of the two fibers is rotated with respect to an axis of asymmetry of the other of the two fibers. Coherent light is provided to a spatial modulation assembly which forms a first diffracted mode beam from the coherent light. Optics rotate a portion of the first diffracted mode beam to form a second diffracted mode beam. The beams are recombined and coupled to the fibers. Then, an optical twist assembly takes the beams exiting the fibers (now affected by the environment) and measures the change in average OAM of each exiting beam. These measurements are correlated to find a direction and an intensity of force or strain on the fibers.

Generally the process occurs in real time and monitors changes in the force.

The two optical fibers may be polarization maintaining fiber, which has asymmetric spatially dependent indices of refraction. The spatial modulation assembly may includes a spatial light modulator configured to apply a holographic grating to the coherent light. The spatial modulation assembly, the optics for rotating, and the optics for recombining may configured in a Mach-Zender configuration. Generally, the first diffracted mode beam and the second diffracted mode beam are orthogonally polarized, and the two optical fibers are configured such that their directions of asymmetry are rotated by 45° with respect to each other. Small variations are common.

The sensor may also be configured to detect changes in temperature or other aspect of the environment as well

A method of sensing both direction and intensity of a force incident on an optical fiber assembly in an environment places two asymmetric index of refraction optical fibers in parallel in an environment to be monitored. The axis of asymmetry of one of the fibers is rotated with respect to an axis of asymmetry of the other fiber. Spatially patterned light having OAM is provided to the fibers upstream of the environment, and exiting beams downstream of the environment are measured, and correlated to detect changes in both direction and intensity of force.

The method of providing spatially patterned light can combine two refracted mode beams having orthogonally polarized vortices as described above.

### BRIEF DESCRIPTION OF THE DRAWINGS

FIG. 1A (prior art) illustrates orbital angular momentum. FIG. 1B (prior art) illustrates a forked grating.

FIG. 2 shows a schematic drawing of an OAM PM fiber sensor setup.

FIG. 3 illustrates various orthogonally polarized vortices.

FIG. 4 is a plot showing the average OAM as a function of temperature for linearly polarized modes.

FIG. 5 is a plot showing the average OAM as a function of temperature for orthogonally polarized modes.

FIG. 6 is a plot showing the average OAM as a function of force.

FIGS. 7 and 8 show the results of force sensing with two fibers oriented 45° with respect to each other.

FIG. 9 is a plot showing experimental measurements of the OAM oscillation frequency for different orientations of the PM-fiber stress rods.

FIG. 10 shows continuous OAM tuning in PM fiber.

### DETAILED DESCRIPTION OF THE INVENTION

Optical fiber sensors are useful for measuring temperature, strain, pressure, vibrations, and refractive index. These devices primarily measure changes in phase, intensity, polarization, or frequency in response to a physical property in the environment. Typical implementations of fiber sensors include fiber-Bragg sensors, distributed acoustic sensors, polarization-based sensors, and interferometric sensors. A fiber-Bragg sensor (FBS) is a type of fiber sensor that utilizes a Bragg grating. This Bragg grating introduces a periodic variation in the refractive index along the fiber. Light propagates through the fiber, interacting with this grating. As a result, certain wavelengths are reflected back and others are transmitted through the fiber. When the fiber is exposed to external stimuli, the grating will shift, causing the wavelength of the reflected light to shift. The reflected light is analyzed to measure parameters such as temperature and pressure. Another technique is a Fabry-Perot sensor which employs a Fabry-Perot cavity, an optical resonator cavity that is formed between two partially reflective surfaces in the fiber. As light enters the cavity, the light is reflected and interference patterns form.

When outside factors such as strain or pressure change the length of this cavity, the interference patterns change. By measuring how these patterns are modified, the magnitude of the applied parameter can be determined.

These devices do offer remarkable sensitivity (see Table 1).

It is further useful to perform azimuthally resolved sensing, in order to resolve the direction of a force on the fiber. A novel azimuthally differentiable fiber sensor based on a pair or polarization maintaining fibers address this feature. The sensor has comparable sensitivity to conventional sensors.

TABLE 1
Temperature and force resolution of presented OAM-based fiber
sensor compared with other high-sensitivity fiber sensors.

| | | | | | Azimuthally |
|---|---|---|---|---|---|
| Sensing | Temperature | | | | Resolved |
| Technique | (° C.) | | Force (N) | | Sensing |
| Fiber-Bragg | 6.3 × 10⁻⁷ | [26] | 4.6 × 10⁻³ | [27] | No |
| Sensors | | | | | |
| Sagnac | 10⁻³ | [28] | 0.012 | [29] | No |
| Interferometric | | | | | |
| Sensors | | | | | |
| Fabry-Perot | 6 × 10⁻⁴ | [30] | 0.1 | [31] | No |

| | | | |
|---|---|---|---|
| Interferometric | | | |
| Sensors | | | |
| New OAM-Based | 2.89 × 10⁻⁴ | 6.1 × 10⁻³ | Yes |
| Sensor | | | |

In this sensor, a change in the orbital angular momentum (OAM) of light is used to measure a temperature or force variation. Azimuthally resolved sensing is enabled by the asymmetric nature of the polarization maintaining fiber that affects the spatially patterned light, here specifically OAM, that is used.

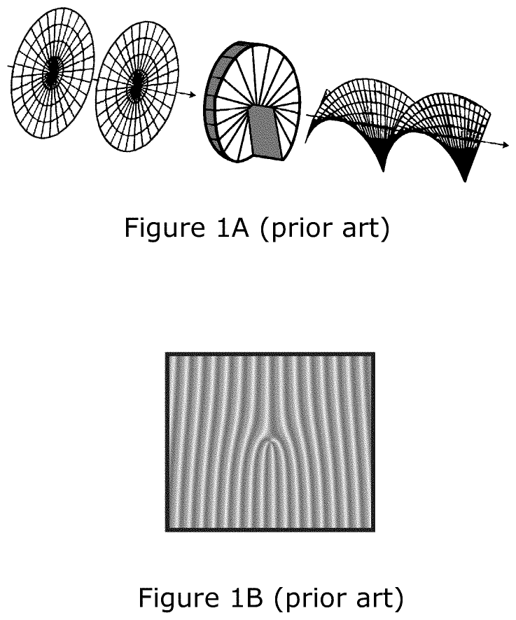

Light can carry two kinds of angular momentum: spin and orbital. See FIG. 1A (prior art) from A. M. Yao et al, Adv. Opt. Photonics 3, 161 (2011) for an example using a spiral phase plate to provide OAM. Spin angular momentum is related to the polarization of the light, while OAM is related to the helical phase front of light. Light carrying OAM winds around the optical axis and has a phase front described by exp (ilφ) where/refers to the winding number and φ is the azimuthal coordinate. OAM also has a quantized value of ±lℏ per photon. In free space, OAM can be generated, for example, by sending a Gaussian beam through a spiral phase plate as shown in FIG. 1A, a cylindrical lens mode converter, or a forked grating as shown in FIG. 1B (prior art), for example implemented on a spatial light modulator (SLM). However, these methods generate OAM beams that may not be as compatible with commercially available fiber. To avoid this possible barrier, optical OAM can be generated from the addition of two Hermite-Gaussian modes, HG₀₁ and HG₁₀, with the correct phase between them. However, this method is difficult to achieve with a standard step-index fiber because there is a four-fold degeneracy of the first higher order mode.

Annular core fibers can be made to overcome this obstacle, though this likely involves custom fiber designs that may be costly and time consuming. As an alternative, a polarization-maintaining (PM) fiber can be used. The stress rods in a PM fiber break the four-fold degeneracy and allow for higher order mode addition to generate a LG₀₁ mode (Laguerre-Gaussian beam) carrying OAM. The spatially dependent index of refraction enables azimuthally differentiable force sensing.

The sensor relies on a change in temperature or force on the fiber causing a variation in the birefringence of the fiber. As a result, the phase between the HG₀₁ and HG₁₀ modes will oscillate between 0 and 2π and the average OAM value will oscillate between ±1ℏ per photon.

Results show that the sinusoidal oscillation rate of the average OAM depends on the polarization of the HG₀₁ and HG₁₀ modes launched into the PM fiber. Thus, the measurements were performed for both orthogonally and linearly polarized beams. Orthogonally polarized beams will have a nearly 14× higher oscillation frequency than linearly polarized beams. For force sensing, this oscillation rate is dependent on the orientation of the PM fiber stress rods. It appears that a maximum frequency oscillation occurs when the stress rods are either in-line or perpendicular to the applied force and the OAM oscillation frequency is generally linearly sensitive to the length of fiber used.

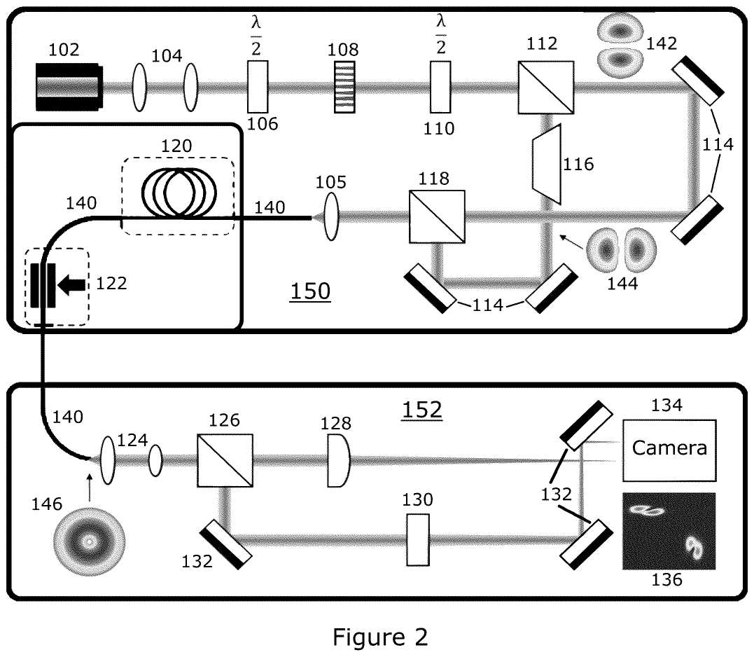

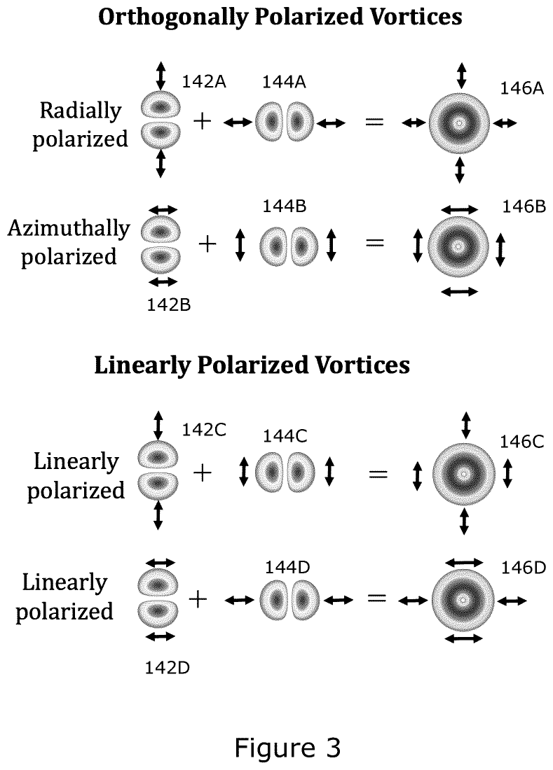

FIG. 2 shows a block diagram of an embodiment of apparatus for measuring temperature and/or strain using OAM. FIG. 3 shows various orthogonally polarized vortices which may be used in the system of FIG. 2. In FIG. 2, the top box 150 indicates the OAM generating portion of the device, while the lower box 152 indicates the optical twist measurement portion of the device. OAM generating assembly 150 is upstream of fiber assembly 140, and optical twist measurement assembly 142 is downstream of fiber assembly 140. OAM generating assembly 150 generates spatially patterned light having OAM, and introduces it to fiber assembly 140. Optical twist measurement assembly 142 detects changing average OAM from the fibers and gleans information about changes in the fiber assembly 140 environment.

The specific device shown in FIG. 2 was experimentally tested by providing temperature variation or strain variation to the polarization maintaining fiber assembly 140. In the experiment, a single asymmetric, spatially dependent index of refraction, fiber was used to test both direction and intensity of force, by rotating the fiber between tests. In actual use fiber assembly 140 comprises two asymmetric fibers rotated with respect to each other in order to measure directional force or strain changes.

The OAM generation assembly is configured to generate spatially patterned light having OAM. A Mach-Zender interferometer structure is used. In this example, coherent light source 102 provides, for example, a HeNe beam which passes through a spatial light modulator (SLM) 108 to create an HG mode. Here, SM 108 creates first mode 142 via a holographic grating and is disposed between polarizers 106, 110. The mode is split by a polarizing beam splitter 112 into two paths and one mode is rotated by dove prism 116 to get mode 144. The modes 142, 144 are recombined via polarizing beam splitter 118 and coupled by optic 105 into a polarization maintaining fiber assembly 140.

The environment being tested in this example is as follows. Either a heat-controlled water bath 120 or a load cell apparatus 122 is used to apply the temperature or force change. The other effect is tested in a later run. In the experimental setup, direction and intensity of force are tested in two different runs, with the asymmetrical fiber rotated in between.

At the fiber assembly 140 output, optical twist measurement assembly 152 uses two cylindrical lenses 128, 130 and a camera 134 to capture images of the light. Signal processing 136 is performed on the captured images, generally in real time to measure the effect on the beam and to monitor values as they change.

In a demonstration of this design, a HeNe laser 102 (λ=633 nm) was followed by optics 104 to produce a Gaussian beam. When this beam passes through a specialized grating 108 on a SLM, the first diffracted mode 142, HG₀₁, is sent through a polarizing beam splitter 112 in a Mach-Zehnder interferometer (further comprising mirrors 114, dove prism 116, and beam splitter 118). In one arm of the beam path, a dove prism 116 is mounted at 45° and rotates the HG₀₁ mode 142 by 90°, resulting in the HG₁₀ mode 144. These two modes 142, 144 are overlapped by optic 105 and coupled into a polarization maintaining fiber assembly 140 (here PM-980-XP from Thorlabs). Both orthogonal and linear polarization beams were utilized in the experiment to exploit different birefringences in the fiber 140. The orthogonal polarization beam utilizes a polarizing beam splitter 118 to recombine the two paths before coupling into the fiber assembly 140. This coupling results in an orthogonally polarized LG₀₁ 146 with an OAM of ±1ℏ per photon.

As an alternative, a linearly polarized beam (lower portion of FIG. 3) is achieved by placing a half wave plate (not shown) into one of the beam paths. The half wave plate rotates the beam's polarization to match that of the other path. A non-polarizing beam splitter is used in place of polarizing beam splitter 118 to recombine the two beam paths. Similarly, this coupling results in a linearly polarized LG₀₁ beam with an OAM of ±1ℏ per photon.

Those skilled in the art will appreciate that while the terms Hermite-Gaussian modes and Laguerre-Gaussian mode are used herein, they are exemplary approximations of the two (or more) modes within the system.

To determine the OAM dependence on temperature change, 1.2 m of the PM-980-XP fiber 140 was placed into a temperature-controlled water bath 120 (here Precision series 51221044). As the temperature of water changed, the resulting change in average OAM was recorded and analyzed. The average OAM is measured through a twist measurement technique in box 152. This technique utilizes two cylindrical lenses 128, 130 with a focal length of 50 cm. The beam via optics 124 is split 126 and one part is sent through a vertically oriented cylindrical lens and the other through a horizontally oriented cylindrical lens and the two beams are recombined, via mirrors 132. A CCD camera 134 having signal processing capability 136 is used to analyze the xy-covariance of the vertically and horizontally oriented beams' intensity distribution. The average OAM can be directly calculated from these covariances. For orthogonally polarized vortices shown at the top of FIG. 3, a polarizer (not shown) was set at 45° at the fiber 140 output to transform the vector vortices into phase vortices. This was carried out because the twist measurement technique, employing cylindrical lenses to measure orbital angular momentum (OAM), is effective for detecting phase vortices.

Force apparatus 122 was used to measure the OAM dependence on a force acting on the fiber 140. Force apparatus 122 includes two plates, between which fiber 140 was placed. A 1-inch disk (here Thorlabs SM1PL) was used to apply a force to the fiber 140 while a load cell (here HT Sensor Technology TAS606) beneath the plate recorded the resultant force acting on the fiber. Fiber rotators (here Thorlabs HFR007) were utilized to rotate the fiber 140 and determine the OAM and force dependence on the fiber orientation.

Water bath 120 and force apparatus 122 were used to simulate the environment in which fiber 140 will be placed in actual use, so they will not be necessary in a commercial device.

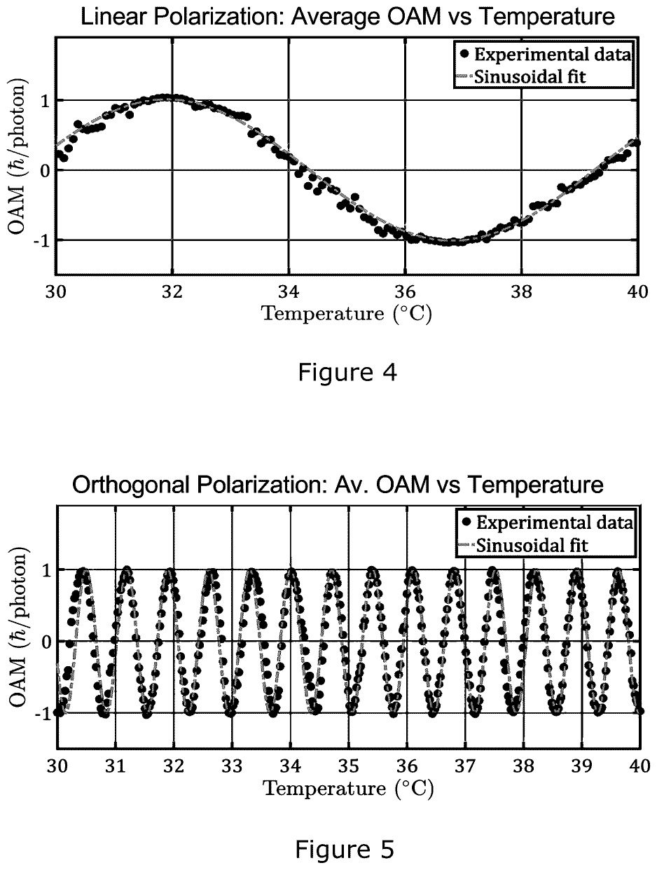

FIG. 4 is a plot showing the average OAM as a function of temperature for linearly polarized modes (bottom of FIG. 3) coupled to the PM fiber 140. Linearly polarized modes exhibited a much smaller birefringence difference and resulted in a lower OAM oscillation frequency due to the temperature driven phase shift.

FIG. 5 is a plot showing the average OAM as a function of temperature for orthogonally polarized modes (top of FIG. 3) coupled to the PM fiber assembly 140. In these conditions, orthogonally polarized modes exhibited a larger birefringence difference resulting in higher OAM oscillation frequencies due to the temperature driven phase shift.

For both orthogonal and linear polarization, the temperature varied between 30-40° C. For orthogonally polarized light (FIG. 5), the average OAM oscillated between ±1ℏ per photon with an oscillation frequency of 1.42 oscillations/C. For linearly polarized light (FIG. 4), this OAM oscillation frequency was much slower at 0.10 oscillations/C.

To quantify the sensitivity of this measurement the minimum detectable change in temperature, 114 δT, will be approximated through Eq. (1).

$$δ T \approx \frac{Δ T}{Δ OAM} {OAM}_{sens} \qquad ( 1 )$$

The ΔT/ΔO AM term corresponds to the maximum slope of the sinusoidal fit. The OAMₛₑₙₛ was calculated as the standard deviation of thirty repeated twist measurements averaged to be 0.002 h per photon. For 1.2 m of fiber, this results in a resolution of 0.289 m° C. and 4.2 m° C. for orthogonally and linearly polarized beams respectively. The resolution is approximately 14× higher for orthogonal polarization, demonstrating the importance of polarization in characterizing the fiber sensor's sensitivity.

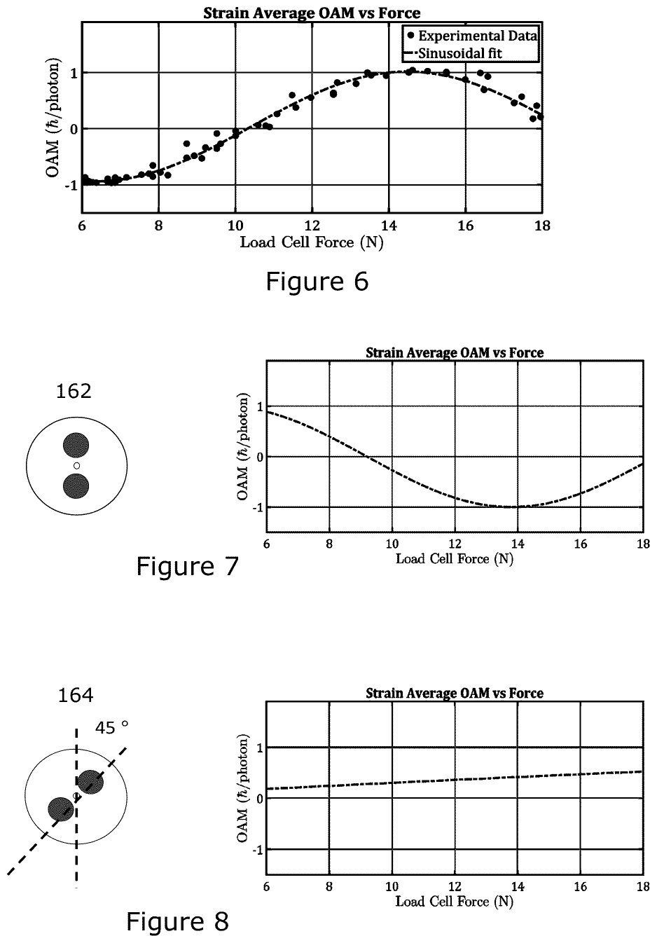

FIG. 6 shows the experimental results for the average OAM of orthogonally polarized light as a function of force applied to fiber assembly 140 by force apparatus 122. The force was directly applied to the fiber assembly using a 1-inch disk, from 6-18 N, and slowly released. The OAM oscillation frequency of the sinusoidal fit for this orientation was recorded, and the fiber was rotated 15°. This process was repeated across the circumference of the fiber resulting in the graph shown in FIG. 7.

FIGS. 7 and 8 show force sensing with two fibers 162, 164 oriented 45° with respect to each other. Fibers 162, 164 have asymmetric spatially dependent indices of refraction. Fiber assembly 140 includes two fibers in order to measure intensity and direction of force at the same time. In general, one fiber is rotated 45° on its axis with respect to the other fiber. Since the OAM oscillation rate in force sensing does depend on the fiber rod orientation, another variable is introduced. A single fiber could be used in applications where the direction of the force on the fiber is constant. In that case, the fiber sensor would act similarly to a load cell. This single fiber system could also be used in situations where the magnitude of a force is constant, but the direction is changing.

But in most applications, an azimuthally resolved or azimuthally differentiable force sensor will be more useful, so fiber assembly 140 includes at least two asymmetric index of refraction fibers. Azimuthally resolved/differentiable means that the sensing system is capable of detecting both the magnitude and direction of a force (e.g. strain). The stress rods of the two fibers are oriented, for example, 45° with respect to each other as in FIGS. 7 and 8. This means that one fiber (162 in FIG. 7) is oriented such that the OAM oscillation frequency is maximized and the other fiber (164 in FIG. 8) is oriented such that the oscillation frequency is minimized. By considering this relationship, the change in the average OAM for the two fibers can be correlated. Thus, both the direction and magnitude of the sensed force can be determined.

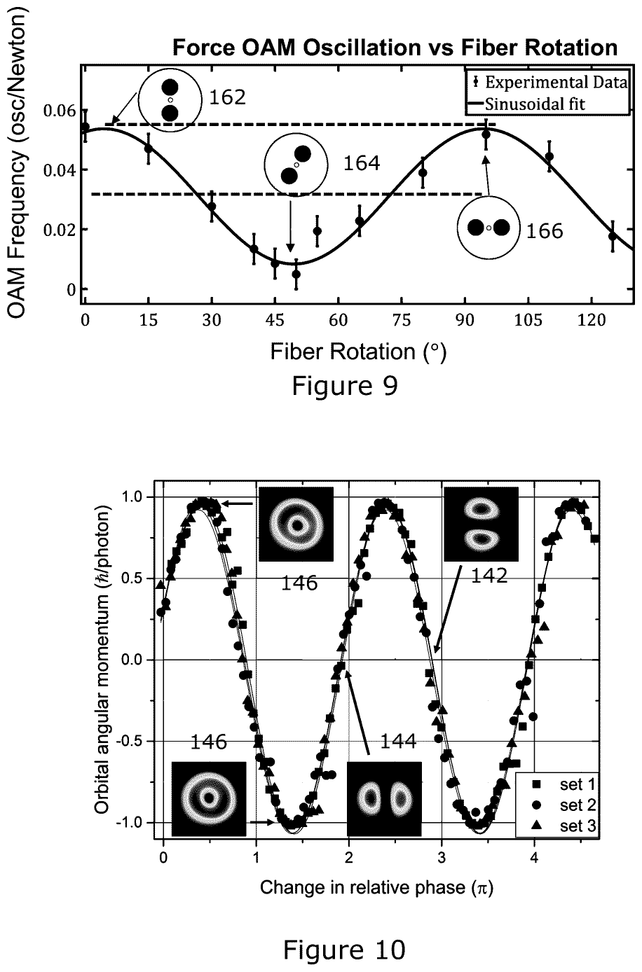

FIG. 9 is a plot showing experimental measurements of the OAM oscillation frequency for different orientations of the PM-fiber stress rods 162, 164, 166. A maximum OAM frequency is achieved when fiber rods are vertically or horizontally oriented. A minimum OAM frequency is achieved when fiber rods are 45° offset from the vertical or horizontal position. A 90° periodicity is seen between the OAM oscillation frequency and the fiber rod orientations. The fastest oscillation frequency occurs when the fiber stress rods are oriented vertically or horizontally and the slowest when the stress rods are 45° offset. To quantify the sensitivity of the force, a similar relation as with temperature is used in Eq. (2).

$$δ F \approx \frac{Δ F}{Δ OAM} OAMsens \qquad ( 2 )$$

The ΔF/OA M corresponds to maximum slope of the sinusoidal fit. The minimum detectable force, or resolution, is dependent on the orientation of the fiber. When the fiber stress rods are 45° offset, the resolution is 77.4 mN, and the resolution is 6.1 mN when the fiber stress rods are oriented vertically or horizontally.

This data demonstrates an azimuthally differentiable fiber sensor. For a force of known magnitude acting on the fiber, the relative direction of this force can be determined. Similarly, if the direction of the force is known, then the magnitude of the force can be measured. However, using only one fiber, both direction and magnitude cannot be quantified.

To discern both the magnitude and direction of a force acting on the sensor, a second fiber is introduced, with the stress rods of the two fibers oriented 45° with respect to each other. This means that one fiber will be oriented such that the OAM oscillation frequency is maximized and the other so the oscillation frequency is minimized. By considering this relationship, the change in the average OAM for the two fibers can be correlated. Thus, both the direction and magnitude of the sensed force can be uniquely determined.

A limitation to consider is related to the 90° periodicity of the OAM frequency and fiber rod orientation relationship. The OAM oscillation frequency can be the same for several different fiber orientations and hence not differentiable for these specific orientations. In this example, the oscillation frequency will be the same at 0° and 90° and at 22.5° and 67.5°. Additionally, the fiber sensor does not differentiate between temperature and force affects.

FIG. 10 is a plot illustrating tunability of OAM in PM fiber. FIG. 10 plots average OAM vs phase between fiber modes. This example demonstrated:
+1 to −1 ℏ average OAM, continuously tunable
Oscillation period: 2π
Measurement uncertainty: ±0.01 ℏ
Beam profile changes between donut and LP₁₁ shapes

While the exemplary preferred embodiments of the present invention are described herein with particularity, those skilled in the art will appreciate various changes, additions, and applications other than those specifically mentioned, which are within the spirit of this invention.

What is claimed is:

1. An azimuthally differentiable fiber sensor comprising:
two optical fibers having asymmetric spatially dependent indices of refraction and disposed in parallel in an environment, wherein an axis of asymmetry of one of the two fibers is rotated with respect to an axis of asymmetry of the other of the two fibers;
a source of coherent light;
a spatial modulation assembly for forming a first diffracted mode beam from the coherent light;
optics for rotating a portion of the first diffracted mode beam to form a second diffracted mode beam;
optics for recombining the remaining first diffracted mode beam and the second diffracted mode beam and coupling the recombined beams into the two optical fibers; and
an optical twist measurement assembly for receiving environmentally affected beams from the two optical fibers and measuring changes in average orbital angular momentum (OAM) of each environmentally affected beam.

2. The fiber sensor of claim 1 further comprising a signal processing element for comparing the measured changes in average OAM and determining an intensity of force and a direction of force applied by the environment.

3. The fiber sensor of claim 2 wherein the force is strain.

4. The fiber sensor of claim 2, wherein the signal processing element is configured to determine an intensity of force and a direction of force in real time.

5. The fiber sensor of claim 1 wherein the two optical fibers are polarization maintaining fiber.

6. The fiber sensor of claim 1 wherein the spatial modulation assembly comprises a spatial light modulator configured to apply a holographic grating to the coherent light.

7. The fiber sensor of claim 1 wherein the spatial modulation assembly, the optics for rotating, and the optics for recombining are configured in a Mach-Zender configuration.

8. The fiber sensor of claim 1 wherein the first diffracted mode beam and the second diffracted mode beam are orthogonally polarized.

9. The fiber sensor of claim 1 wherein the two optical fibers are configured such that their directions of asymmetry are rotated by 45° with respect to each other.

10. The fiber sensor of claim 1 further configured to detect changes in temperature in the environment.

11. A method of sensing both direction and intensity of a force incident on an optical fiber assembly in an environment comprising the steps of:
placing two asymmetric index of refraction optical fibers in parallel in the environment with an axis of asymmetry of one of the fibers rotated with respect to an axis of asymmetry of the other fiber, the two fibers forming the optical fiber assembly;
providing spatially patterned light having OAM to the fibers upstream of the environment;
receiving exiting beams from the fibers downstream of the environment;
measuring change in average OAM of each exiting beam.

12. The method of claim 11 further comprising the step of correlating the change in average OAM of each exiting beam and determining direction and intensity of a force incident on the optical fiber assembly.

13. The method of claim 12 wherein the determining step occurs repeatedly in real time.

14. The method of claim 12 wherein the force being measured is strain.

15. The method of claim 11 wherein the step of providing spatially patterned light combines two refracted mode beams having orthogonally polarized vortices.

16. The method of claim 11 wherein the fibers comprise polarization maintaining fiber.

17. The method of claim 11 wherein the axes of asymmetry are 45° apart.

18. An azimuthally differentiable fiber sensor comprising:
an OAM generation assembly configured to generate spatially patterned light having OAM;
an optical fiber assembly comprising two asymmetric index of refraction optical fibers in parallel with an axis of asymmetry of one of the fibers rotated with respect to an axis of asymmetry of the other fiber; and
an optical twist measurement assembly;
wherein the OAM generation assembly is configured to introduce the spatially patterned light to the two fibers; and
wherein the optical twist measurement assembly is configured to receive light exiting from the two fibers and to measure change in average OAM of each exiting beam.

19. The fiber sensor of claim 18, further comprising a signal processing element configured to compare the measured change in average OAM of the exiting beams and to determine an intensity of force and a direction of force applied to the optical fiber assembly.

20. The fiber sensor of claim 18 wherein the OAM generation assembly includes a spatial light modulator configured to apply a holographic grating to coherent input light.
